(19) United States
(12) Patent Application Publication
(10) Pub. No.: US 2008/0314387 A1
(43) Pub. Date: Dec. 25, 2008

(54) Second Stage Of A Regulator For Scuba Breathing Apparatus

(75) Inventor: Alberto Belloni, Genova (IT)

Correspondence Address: REINHART BOERNER VAN DEUREN P.C., 2215 PERRYGREEN WAY, ROCKFORD, IL, 61107, US

(73) Assignee: Scubapro Europe S.r.L., Genova (IT)

(21) Appl. No.: 12/202,890

(22) Filed: Sep. 2, 2008

Related U.S. Application Data
(63) Continuation of application No. PCT/EP2007/051910, filed on Feb. 28, 2007.

(30) Foreign Application Priority Data
Mar. 3, 2006 (IT) SV2006A000006

(51) Int. Cl. A62B 18/02

(52) U.S. Cl. 128/205.25

(57) ABSTRACT

A second stage of a regulator for scuba breathing apparatus which comprises a body having an extension sleeve for delivering a breathing gas mixture to a user and a replaceable mouthpiece element comprising a connecting sleeve, which connecting sleeve of the mouthpiece is elastically deformable and may be fitted on said delivery sleeve of the second stage. According to an embodiment of the invention, there are provided separate and independent pull-out resistant means for mechanically locking the mouthpiece element to the delivery sleeve and separate and independent means for providing a hermetic seal between the mouthpiece element and the delivery sleeve.

### CROSS-REFERENCE TO RELATED PATENT APPLICATIONS

This patent application is a continuation of co-pending PCT Application No. PCT/EP2007/051910, filed Feb. 28, 2007, which claims the benefit of Italian Patent Application No. SV2006A000006, filed Mar. 3, 2006, the entire teachings and disclosure of which are incorporated herein by reference thereto.

### FIELD OF THE INVENTION

The present invention relates to a second stage of a regulator for scuba breathing apparatus which comprises a body having an extension sleeve for delivering a breathing gas mixture to a user and a replaceable mouthpiece element comprising a connecting sleeve, which connecting sleeve of the mouthpiece is elastically deformable and may be fitted on said delivery sleeve of the second stage.

### BACKGROUND OF THE INVENTION

In scuba regulators, there is the need to provide a fluid tight connection between the mouthpiece and the second stage and means are well known and widely used for removably fixing the mouthpiece to the body of the second stage, particularly to the delivery sleeve.

FR 2 729 300 and U.S. Pat. No. 5,829,432, by the applicant hereof, disclose a second stage of a regulator, having a mouthpiece which is locked to the sleeve of the second stage by means of a clamp having opening and closing means.

EP 307 314 discloses a mouthpiece that is locked to the sleeve of the second stage by means of an openable ring, having a lock screw.

U.S. Pat. No. 5,755,222 discloses a quick-release clamp having an adjustable length, for attaching the mouthpiece of a regulator to the sleeve connected to a second stage body.

While these means satisfactorily serve their function, they still suffer from certain drawbacks.

Such means provide a fluid-tight connection between the mouthpiece and the regulator body, to prevent water from entering the mouthpiece during breathing, and also prevent the mouthpiece from being pulled out of the sleeve of the regulator body. The means are generally provided as aesthetically unpleasing clamps or rings, having elements for quick opening and closing thereof, allowing replacement of the mouthpiece element, when needed. These clamps, and particularly the elements for opening them, project from the regulator body and might accidentally be caught up in other elements of the diver's equipment or the environment, thereby causing the ring that locks the mouthpiece to the second stage to be accidentally opened, and the air source to be pulled off from the user's mouth.

The elements for opening and closing the clamps are hooks that are designed to be engaged in clamp holes in the closed condition. Such parts are small and brittle, and are subject to wear or rupture, especially when stressed by frequent closing/opening operations, during mouthpiece replacement.

Furthermore, the clamps or rings are tightly fitted on the surface of the sleeve to prevent any ingress of water, and if they are opened by inexpert users, an excessive unlocking force might be exerted on the closing elements, which might cause certain parts to be broken and the whole clamp to be necessarily replaced. Finally, the clamps or the like are relatively expensive.

### BRIEF SUMMARY OF THE INVENTION

The object of an embodiment of the present invention is to provide a second stage of a regulator for scuba breathing apparatus, which may simply and inexpensively obviate the drawbacks of prior art means for fixing the mouthpiece of a regulator to the sleeve connected with a second stage body.

One embodiment of the invention achieves the above purposes by providing a second stage of a regulator for scuba breathing apparatus according to the preamble of claim 1, wherein there are provided separate and independent pull-out resistant means for mechanically locking the mouthpiece element to the delivery sleeve and separate and independent means for providing a hermetic seal between the mouthpiece element and the delivery sleeve.

An advantageous embodiment of the second stage of a regulator for scuba breathing apparatus according to the present invention comprises a mouthpiece element having a connecting sleeve that can be operatively associated to the delivery sleeve connected with the body of a second stage of a regulator by means of a locking element to be introduced transversely to the second stage mouthpiece/sleeve axis.

The mouthpiece element, and particularly its connecting sleeve, is fitted on the delivery sleeve of the second stage, which has at least one hollow pin and/or tooth, transverse to the mouthpiece/sleeve axis, for elastic engagement in a corresponding recess or blind or through hole on the connecting sleeve of the mouthpiece. Then, the locking element is introduced in the at least one hole of the pin and/or tooth.

The provision of pins and/or teeth on the delivery sleeve and of holes on the mouthpiece, or vice versa, allows the mouthpiece element to be held in position even when the locking element is not in place, to securely prevent the mouthpiece from being pulled off from the source of breathable air.

Such pins and/or teeth and the corresponding holes, whether or not secured by the locking element, form separate and independent pull-out resistant means for mechanically locking the mouthpiece element to the delivery sleeve.

Mechanical fixation of the mouthpiece to the second stage occurs without using any clamp or ring, by means of pins and/or teeth engaged in mouthpiece holes, whereas the fluid-tight connection between the mouthpiece and the regulator body to prevent water from entering the mouthpiece, is provided by means of a continuous annular flange on the delivery sleeve of the second stage, which is introduced in a corresponding continuous groove on the inner surface of the connecting sleeve of the mouthpiece element.

Fluid tightness is not provided by clamps or rings clamping together the surfaces of the mouthpiece sleeve and the delivery sleeve, but by forming the groove of a slightly smaller size than the flange so that, when the mouthpiece element is elastically forced onto the connecting sleeve, conical surfaces are generated which cooperate by mutual compression, thereby preventing any ingress of water in the mouthpiece and any breathable mixture leakage.

According to an embodiment of the present invention, a stable and solid mechanical fluid-tight connection is provided between the mouthpiece and the second stage body by separate and independent means, with no projecting elements like those provided in prior art and with no possible catching up and release of parts, which affords the apparent functional advantage of preventing any accidental separation of the mouthpiece element or any ingress of water.

Furthermore, mouthpiece fixation, which can also occur without using locking elements, thanks to embodiments of the present invention, is inexpensive and more aesthetically pleasing than in prior art lock devices.

Further characteristics and improvements will form the subject of the claims appended hereto.

### BRIEF DESCRIPTION OF THE DRAWINGS

The features and advantages of the invention will appear more clearly from the following description of a few embodiments shown in the accompanying drawings, in which:

FIG. 1 is a perspective view of the mouthpiece element and the delivery sleeve of this invention, in a disengaged condition;

FIG. 2 is a cross sectional view of the locking element, engaged in the corresponding recesses or holes;

FIG. 3 is a cross sectional view of the sealing means between the mouthpiece element and the delivery sleeve;

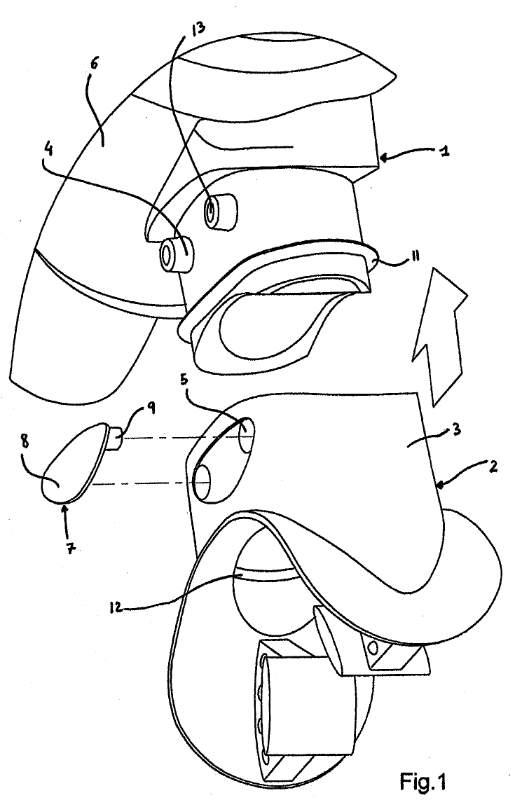

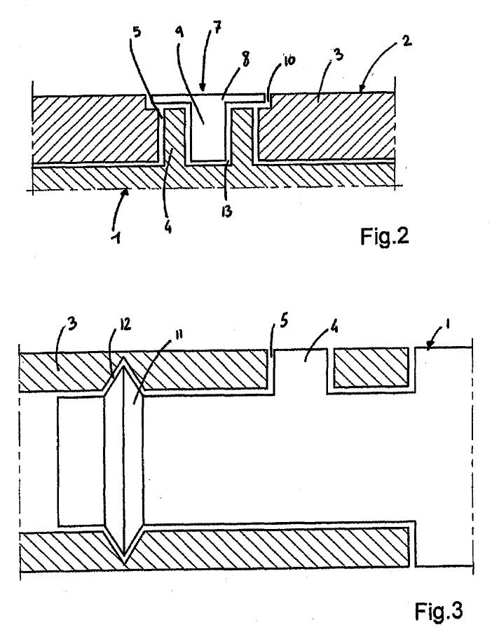

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF EMBODIMENTS OF THE INVENTION

Referring to the figures, the second stage of the regulator comprises a body 6 which is designed to reduce the pressure of the breathable mixture from an intermediate first stage outlet pressure to a low breathing pressure. Such body 6 has an extension sleeve 1 for delivering the breathable mixture to the user and a mouthpiece element 2 that can be easily removed from the body 6 of the second stage when needed, i.e. when the mouthpiece element 2 is excessively worn or has to be replaced for hygienic reasons, particularly when the regulator is used by more than one person.

Such replaceable mouthpiece element 2 comprises a connecting sleeve 3, which is elastically deformable and may be fitted on said delivery sleeve 1 of the body 6 of the second stage, thanks to its soft material, particularly silicone or the like.

The mouthpiece element 2, and particularly its connecting sleeve 3 is attached to the delivery sleeve 1 by separate and independent pull-out resistant mechanical locking means, whereas fluid-tightness between said mouthpiece element 2, and particularly its connecting sleeve 3, and the delivery sleeve 1 is provided by separate and independent sealing means.

The mouthpiece element 2 may be locked to the delivery sleeve 1 by means of at least one radial pin and/or tooth 4, or at least one pin and/or tooth 4 transverse to the axis along which said delivery sleeve 1 and connection sleeve 3 are joined together. The pin and/or tooth 4 is formed on the delivery sleeve 1 of the second stage and allows attachment of the mouthpiece element 2 to the second stage, by engagement thereof in a corresponding recess or blind or through hole 5 on the connecting sleeve 3 of the mouthpiece 2.

The teeth and/or pins may be formed on the connecting sleeve 3 of the mouthpiece 2 for engagement in corresponding recesses or blind or through holes on the delivery sleeve 1 of the second stage.

In a preferred embodiment, two pins and/or teeth 4 are provided on the delivery sleeve 1, in circumferentially spaced positions, in an area of the delivery sleeve 1 that corresponds to the half of said sleeve 1 on its side for connection to the body 6 of the second stage.

When the connecting sleeve 3 of the mouthpiece 2 is fitted on the delivery sleeve 1 of the second stage, these pins and/or teeth engage in two corresponding recesses or blind or through holes 5 of the connecting sleeve 3 of the mouthpiece 2.

For the safest attachment of the mouthpiece to the regulator, the pins and/or teeth 4 have holes 13 for engagement of the coupling pins 9 of the locking element 7 which provides a further lock arrangement, in that it prevents disengagement of pins and/or teeth 4 even under strong translational and rotational forces.

This simple member 7 allows the mouthpiece 2 to be locked to the sleeve of the second stage of a regulator without using any ring or clamp, which normally has projecting parts and is aesthetically unpleasing, and subject to accidental rupture or opening.

The locking element 7 is formed as a large-head plate-like member 8 having at least one coupling pin 9 of such a shape that the coupling pin 9 may be removably introduced by elastic force and/or snap fit in the holes 13 of the pins and/or teeth 4 of the delivery sleeve 1, which are in turn inserted in the corresponding recesses and blind or through holes 5 of the connecting sleeve 3. To obtain an improved aesthetic aspect of the second stage of a regulator and to provide a one-piece effect between the mouthpiece and the regulator body, the plate-like member 8 is conformed in such a manner as to wholly cover the pins and/or teeth 4, whose holes 13 receive the corresponding coupling pins 9 of the locking element and its surface may act as a support for written markings, such as the product trademark or the like. Furthermore, to avoid the provision of parts projecting out of the surfaces of the sleeves 1, 3, recesses 10 may be formed on the outer surface of the connecting sleeve 3 for receiving the plate-like member 8 of the at least one locking element 7.

For a safe fluid-tight effect, which can prevent any ingress of water or leakage of the breathable mixture from the second stage, separate and independent hermetically sealing means are provided between the mouthpiece and the regulator, i.e. between the connecting sleeve 3 and the delivery sleeve 1, particularly a continuous flange 11 and a corresponding groove 12.

The outer surface of the delivery sleeve 1 of the second stage has a continuous peripheral flange 11 at its end facing the mouthpiece element 2, which is designed to be engaged in a corresponding continuous groove 12 formed on the inner surface of the connecting sleeve 3 of the mouthpiece element 2.

The axial distance between the peripheral flange 11 and the at least one pin and/or tooth 4 on the delivery sleeve 1 corresponds to the axial distance between the at least one corresponding recess or blind or through hole 5 and the inner groove 12 for engagement of the flange 11 with the connecting sleeve 3, so that, in the mutual coupling position of the mouthpiece element 2 and the delivery sleeve 1 of the second stage, each pin and/or tooth 4 is engaged in the corresponding recess or blind or through hole 5 and the outer peripheral flange 11 of the delivery sleeve 1 is also engaged in the inner groove 12 of the connecting sleeve 3 of the mouthpiece 2.

In a preferred embodiment, the continuous flange 11 has a pointed, particularly triangular or conical, shape. The section of the groove 12, particularly when viewed in a radial and/or axial direction, is slightly smaller than the corresponding flange 11, so that, when said groove 12 is engaged with said flange 11 by elastic deformation and force fit, conical surfaces are generated which cooperate by mutual compression, to provide fluid tightness, against any ingress of water in the mouthpiece.

Particularly, when the mouthpiece element 2 and the delivery sleeve 1 of the second stage are mutually coupled, the end of the flange 11, particularly having a pointed or cusped shape, slightly cuts into the material of the bottom of the groove 12, thereby enhancing the adhesion between the surfaces of the two sleeves 1, 3 and the sealing effect there between.

In a further embodiment, to prevent the connecting sleeve 3 from rotating on the delivery sleeve 1 even when no locking element is provided, such as locking elements, pins and/or teeth or flanges, the free end portion of the delivery sleeve 1 has a saddle shape which corresponds and is complementary to an abutment surface of the inner wall of the connecting sleeve 3.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A second stage of a regulator for scuba breathing apparatus comprising:
a body having an extension sleeve for delivering a breathing gas mixture to a user and a replaceable mouthpiece element comprising a connecting sleeve, which connecting sleeve of the mouthpiece is elastically deformable and may be fitted on said delivery sleeve of the second stage, characterized in that there are provided separate and independent pull-out resistant means for mechanically locking the mouthpiece element to the delivery sleeve and separate and independent means for providing a hermetic seal between the mouthpiece element and the delivery sleeve.

2. The second stage of a regulator for scuba breathing apparatus as claimed in claim 1, wherein said pull-out resistant mechanical locking means consist of at least one radial pin and/or tooth, or at least one pin and/or tooth transverse to the axis of said delivery sleeve and connection sleeve, which pin and/or tooth is formed on the delivery sleeve of the second stage and engages in a corresponding recess or blind or through hole of the connecting sleeve of the mouthpiece or vice versa.

3. The second stage of a regulator for scuba breathing apparatus as claimed in claim 2 wherein the replaceable mouthpiece element, and particularly its connecting sleeve is made of a soft material.

4. The second stage of a regulator for scuba breathing apparatus as claimed in claim 1 wherein said mouthpiece element is elastically forced in a fluid-tight manner by its connecting sleeve on the delivery sleeve.

5. The second stage of a regulator for scuba breathing apparatus of claim 1, wherein two pins and/or teeth are provided on the delivery sleeve and engage in two corresponding recesses or blind or through holes of the connecting sleeve of the mouthpiece.

6. The second stage of a regulator for scuba breathing apparatus as claimed in claim 5, wherein the pins and/or teeth on the delivery sleeve are in circumferentially spaced relation.

7. The second stage of a regulator for scuba breathing apparatus as claimed in claim 5 wherein the at least one pin and/or tooth has a hole in it.

8. The second stage of a regulator for scuba breathing apparatus as claimed in claim 5, wherein the at least one pin and/or tooth is located in an area of the delivery sleeve that corresponds to the half of said sleeve on its side for connection to the body of the second stage.

9. The second stage of a regulator for scuba breathing apparatus as claimed in claim 5, wherein at least one element is provided for locking at least one pin and/or tooth in the at least one corresponding recess or blind or through hole.

10. The second stage of a regulator for scuba breathing apparatus as claimed in claim 9 wherein the locking element is formed as a large-head plate-like member having at least one coupling pin of such a shape that said coupling pin may be removably introduced in the holes of the pins and/or teeth of the delivery sleeve, which are in turn inserted in the corresponding recesses and blind or through holes of the connecting sleeve.

11. The second stage of a regulator for scuba breathing apparatus as claimed in claim 10, wherein said coupling pin is removably engaged by elastic force and/or snap fit in the corresponding hole of the pin and/or tooth of the delivery sleeve of the second stage.

12. The second stage of a regulator for scuba breathing apparatus as claimed in claim 10, wherein one locking element is only provided, which is formed as a single large-head plate-like member having two or more coupling pins, wherein said plate-like member is conformed in such a manner as to wholly cover the pins and/or teeth, whose holes receive the corresponding coupling pins.

13. The second stage of a regulator for scuba breathing apparatus as claimed in claim 10, wherein at least one recess is formed on the outer surface of the connecting sleeve for receiving the plate-like member of the at least one locking element.

14. The second stage of a regulator for scuba breathing apparatus as claimed in claim 10, wherein the surface of the plate-like member having no coupling pins may act as a support for written markings, such as the product trademark or the like.

15. The second stage of a regulator for scuba breathing apparatus as claimed in claim 1 wherein the separate and independent hermetically sealing means between the mouthpiece element and the delivery sleeve are a continuous peripheral flange to be engaged in a corresponding continuous groove.

16. The second stage of a regulator for scuba breathing apparatus as claimed in claim 15, wherein the continuous peripheral flange is formed on the outer surface of the delivery sleeve of the second stage, next to its end facing the mouthpiece element, whereas the corresponding continuous groove is formed on the inner surface of the connecting sleeve of the mouthpiece element.

17. A second stage of a regulator for scuba breathing apparatus as claimed in claim 15, wherein the continuous flange has a pointed, particularly triangular or conical, shape.

18. The second stage of a regulator for scuba breathing apparatus as claimed in claim 15, wherein the section of the groove, particularly when viewed in a radial and/or axial direction, is slightly smaller than the corresponding flange, so that, when said groove is engaged with said flange by elastic deformation and force fit, conical surfaces are generated which cooperate by mutual compression, to provide fluid tightness.

19. The second stage of a regulator for scuba breathing apparatus as claimed in claim 15, wherein when the mouthpiece element and the delivery sleeve of the second stage are mutually coupled, the end of said flange, particularly having a pointed or cusped shape, slightly cuts into the material of the bottom of the groove.

20. A second stage of a regulator for scuba breathing apparatus as claimed in claim 5 of the preceding claims,
wherein the separate and independent hermetically sealing means between the mouthpiece element and the delivery sleeve are a continuous peripheral flange to be engaged in a corresponding continuous groove;
wherein the axial distance between the peripheral flange and the at least one pin and/or tooth on the delivery sleeve corresponds to the axial distance between the at least one corresponding recess or blind or through hole and the inner groove for engagement of the flange with the connecting sleeve, so that, in the mutual coupling position of the mouthpiece element and the delivery sleeve of the second stage, each pin and/or tooth is engaged in the corresponding recess or blind or through hole and the outer peripheral flange of the delivery sleeve is also engaged in the inner groove of the connecting sleeve of the mouthpiece.

21. The second stage of a regulator for scuba breathing apparatus as claimed in claim 18, wherein the free end portion of the delivery sleeve has a saddle shape which corresponds and is complementary to an abutment surface of the inner wall of the connecting sleeve.
